(19) United States
(12) Patent Application Publication
(10) Pub. No.: US 2007/0052606 A1
(43) Pub. Date: Mar. 8, 2007

(54) Antenna alignment tool and method

(76) Inventor: James D. Gold, Frederick, CO (US)

Correspondence Address: LAW OFFICE OF DALE B. HALLING, LLC, 655 SOUTHPOINTE CT, SUITE 100, COLORADO SPRINGS, CO, 80906, US

(21) Appl. No.: 11/511,819

(22) Filed: Aug. 29, 2006

Related U.S. Application Data
(60) Provisional application No. 60/714,614, filed on Sep. 7, 2005.
(60) Provisional application No. 60/738,644, filed on Nov. 21, 2005.

(51) Int. Cl. H01Q 3/00

(52) U.S. Cl. 343/760; 343/878

(57) ABSTRACT

An antenna alignment tool has a housing. A mounting system attaches the housing to the antenna. A compass is attached to the housing. A level may also be attached to the housing.

### RELATED APPLICATIONS

The present invention claims priority on provisional patent applications, Ser. No. 60/714,614, filed on Sep. 7, 2005, entitled “Antenna Alignment Tool” and Ser. No. 60/738,644, filed on Nov. 21, 2005, entitled “Antenna Attachment” and are hereby incorporated by reference.

### FIELD OF THE INVENTION

The present invention relates generally to the field of antennas and more particularly to an antenna alignment tool and method.

### BACKGROUND OF THE INVENTION

Antennas for cellular telephones and other communication systems have to be accurately aligned to perform correctly. If an antenna is not properly aligned, the communication system will not perform as engineered. For cellular telephone systems this can result is dead spots and dropped calls. Presently, antennas for cellular telephone systems are aligned by a surveyor. Commonly, the surveyor is not an employee of the cellular telephone installation company. As a result, the surveyor has to be scheduled into the project and a construction or installation crew has to wait until the surveyor shows up. In addition, it takes the surveyor anywhere from half an hour to an hour to properly survey the antenna and certify that it is correctly pointed. This is expensive and time consuming.

Thus there exists a need for an antenna alignment tool that is easy to use, does not require the expertise of a surveyor and is inexpensive.

### SUMMARY OF INVENTION

An antenna alignment tool that overcomes these and other problems has a platform. A mounting system attaches the platform to an antenna. A compass is attached to the platform. A level may also be attached to the platform. The user attaches the tool to the back of the antenna so that the platform is perpendicular with the axis of the antenna. The user then reads the compass to determine the azimuth of the antenna. The level or an angle finder can be used to determine the antenna's down-tilt.

In one embodiment, an antenna alignment tool has a sighting device. The sighting device has a reticule and a compass is aligned with the axis of the sighting device. The sighting device may be a monocular. The user, who is on the ground, aligns the reticule on the center of the antenna. The user then moves until each of the quadrants of the reticule are equally filled with the antenna. The user then uses the compass to determine the azimuth of the antenna.

This antenna alignment tool is easy to use, does not require the expertise of a surveyor and is inexpensive.

### BRIEF DESCRIPTION OF THE DRAWINGS

FIG. 1 is a schematic side view of an antenna alignment tool and antenna in accordance with one embodiment of the invention;

FIG. 2 is a schematic top view of an antenna alignment tool in accordance with one embodiment of the invention;

FIG. 3 is a schematic side view of an antenna alignment tool and antenna in accordance with one embodiment of the invention;

FIG. 4 is a view of the antenna through a reticule in accordance with one embodiment of the invention;

FIG. 5 is a flow chart of the steps of aligning an antenna in accordance with one embodiment of the invention; and

FIG. 6 is a flow chart of the steps of aligning an antenna in accordance with one embodiment of the invention.

### DETAILED DESCRIPTION OF THE DRAWINGS

The present invention relates to an antenna alignment tool. In one embodiment, the antenna alignment tool has a platform. A mounting system attaches the alignment platform or housing to the antenna. The platform has a digital compass. The digital compass reads the azimuth of the antenna.

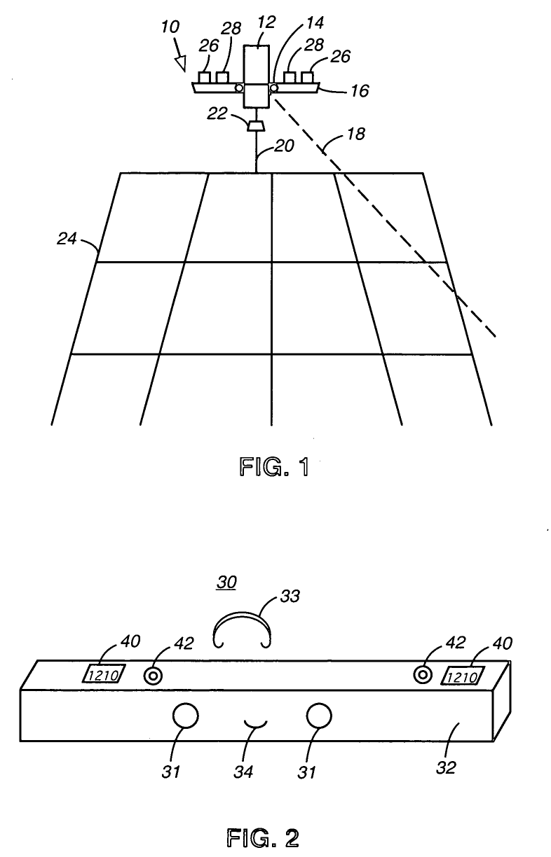

FIG. 1 is a schematic side view of an antenna alignment tool 10 and antenna 12 in accordance with one embodiment of the invention. The antenna alignment tool 10 has a mounting system 14 that attaches to the antenna 12. In one embodiment, the mounting system 14 is a bungee cord that wraps around the antenna 12 and the tool 10. Note that the mounting system 14 may be any attachment device or other device that aligns the platform or housing 16 perpendicular with the antenna axis 18. Note however, that the tool may be designed so that the housing 16 is aligned parallel with the antenna. Commonly, cellular antennas have a flat back surface and the housing 16 has a machined flat surface. By making sure these two flat surfaces are in contact, the housing 16 is aligned perpendicular with the antenna's axis 18. The antenna 12 may have a coupling 22 that allows the antenna's azimuth and down-tilt to be adjusted. The antenna 12 is normally mounted on a tower or platform 24. The antenna alignment tool 10 has a compass 26 and a level 28 attached to the platform 16. In one embodiment, the compass 26 is a digital compass and the level is a digital level. Once the antenna alignment tool 10 is properly attached to the antenna 12, the compass reads the azimuth of the antenna and the digital level can be used to read any down-tilt. A picture may be taken to verify that the antenna is properly aligned. In one embodiment, the housing 16 and mounting bracket are made of non-metallic material. Metallic material may interfere with the accuracy of the compass 26. In addition, the platform extends away from the vertical support 20 and antenna 12 to move the compass away from any metal associated with the antenna 12 or support 20.

FIG. 2 is a schematic top view of an antenna alignment tool 30 in accordance with one embodiment of the invention. The tool 30 has a mounting system that in one embodiment is a pair of holes 31 in the housing 32 and a bungee cord 33. The surface 34 of the housing 32 is precision machined to be a flat surface. This flat surface 34 is held against a flat surface on the back of the antenna to align the tool 20 with the antenna's axis. Note that the mounting system may be any device that allows the tool 30 to be aligned with the antenna's axis and the term “mounting system” should be read consistent with this broad definition. A compass 40 and a level 42 are attached to the housing 32. In one embodiment, the compass 40 and level 42 are embedded in the housing 32 to provide protection against accidental bumps. The compass 40 may be a digital compass. The level may be a digital level. The tool is made of non-metallic materials.

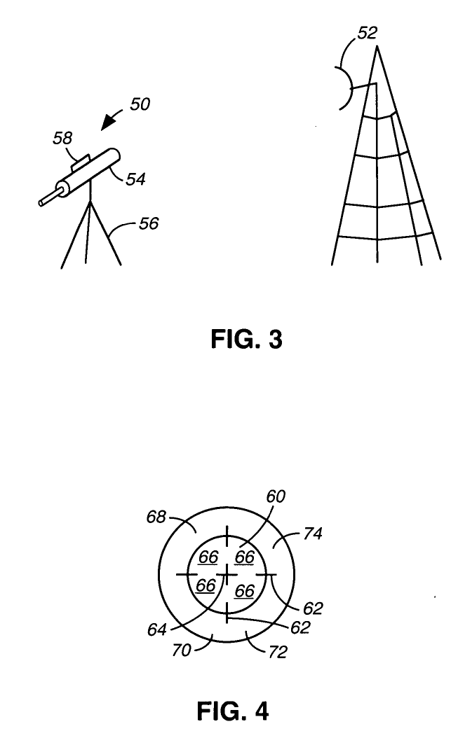

FIG. 3 is a schematic side view of an antenna alignment tool 50 and antenna 52 in accordance with one embodiment of the invention. The tool 50 has a sighting device 54 that may be a monocular. The monocular 54 may be mounted on a tripod 56. A compass 58 is aligned with the sighting axis of the monocular 54. The compass 58 may be integrated into the monocular 54 or maybe mounted on or near the monocular 54. FIG. 4 is a view of the antenna 60 through a reticule 62 in accordance with one embodiment of the invention. The monocular 54 has a reticule 62. The user sights the antenna 60 through the monocular 54. The user aligns the center 64 of the reticule 62 on the center of the antenna 60. The user then moves, generally left or right, until equal parts 66 of the antenna 60 fill each quadrant 68, 70, 72, 74 of the reticule 62. The user then reads the compass to determine the azimuth of the antenna. Note that the compass will commonly read 180 degrees different or anti-parallel with the azimuth of the antenna 52.

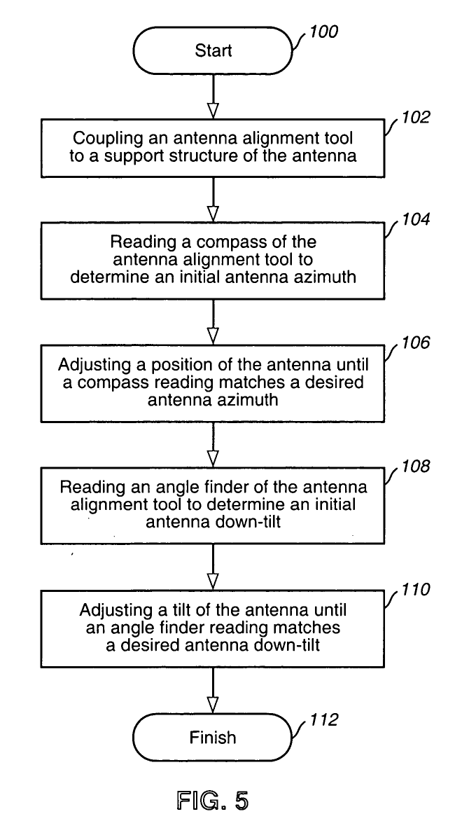

FIG. 5 is a flow chart of the steps of aligning an antenna in accordance with one embodiment of the invention. The process starts, step 100, by coupling the antenna alignment tool to a support structure of the antenna at step 102. A compass is read to determine an initial antenna azimuth at step 104. A position of the antenna is adjusted until the compass reading matches a desired antenna azimuth at step 106. An angle finder is read to determine an initial antenna down-tilt at step 108. At step 110 the tilt of the antenna is adjusted until the angle finder reading matches a desired antenna down-tilt which ends the process at step 112.

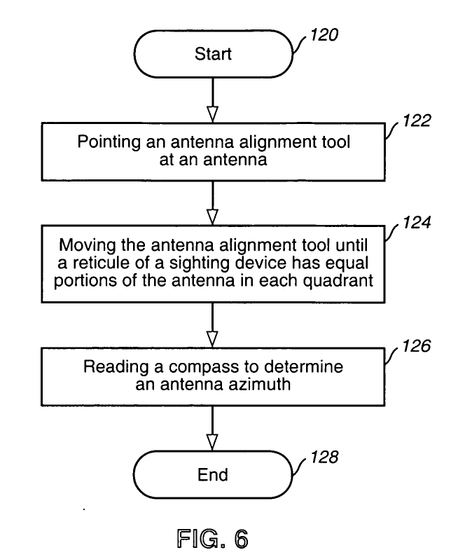

FIG. 6 is a flow chart of the steps of aligning an antenna in accordance with one embodiment of the invention. The process starts, step 120, by pointing an antenna alignment tool at an antenna at step 122. The antenna alignment tool is moved until a reticule of a sighting device has equal portions of the antenna in each quadrant of the reticule at step 124. At step 126 a compass is read to determine the antenna azimuth which ends the process at step 128.

Thus there has been described an antenna alignment tool that is easy to use, does not require the expertise of a surveyor and is inexpensive.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. An antenna alignment tool, comprising:
a housing;
a mounting system for attaching the housing to an antenna; and
a compass attached to the housing.

2. The tool of claim 1, wherein the mounting system attaches to a flat back surface of the antenna.

3. The tool of claim 1, wherein the housing is made of a non-metallic material.

4. The tool of claim 3, further including a level attached to the housing.

5. The tool of claim 4, wherein the level is an electronic level.

6. The tool of claim 5, wherein the compass is an electronic compass.

7. An antenna alignment tool, comprising:
a sighting device have a reticule;
a platform holding the sighting device; and
a compass aligned with the sighting device.

8. The tool of claim 7, wherein the compass is integrated into the sighting device.

9. The tool of claim 8, wherein the sighting device is a monocular.

10. The tool of claim 9, wherein the platform is made of a non-metallic material.

11. A method of aligning an antenna, comprising the steps of:
a) coupling an antenna alignment tool to the antenna;
b) reading a compass of the antenna alignment tool to determine an initial antenna azimuth; and
c) adjusting a position of the antenna until a compass reading matches a desired antenna azimuth.

12. The method of claim 11, further including the steps of:
d) reading an angle finder of the antenna alignment tool to determine an initial antenna down-tilt;
e) adjusting a tilt of the antenna until an angle finder reading matches a desired antenna down-tilt.

13. The method of claim 12, further including the step of:
f) taking a picture of the angle finder reading and the compass reading.

14. A method of aligning an antenna, comprising the steps of:
a) pointing an antenna alignment tool at an antenna;
b) moving the antenna alignment tool until a reticule of a sighting device has equal portions of the antenna in each quadrant; and
c) reading a compass to determine an antenna azimuth.

15. The method of claim 14, further including the steps of:
d) determining if the antenna azimuth is the same as a desired antenna azimuth; and
e) when the antenna azimuth is not the same as the desired antenna azimuth, adjusting the azimuth of the antenna;
f) repeating steps b-d.
